(19) United States
(12) Patent Application Publication
(10) Pub. No.: US 2025/0307084 A1
(43) Pub. Date: Oct. 2, 2025

(54) SYSTEM AND METHOD FOR PERFORMING A BACKUP OPERATION

(71) Applicant: Druva Inc., Santa Clara, CA (US)

(72) Inventors: Sudhakar PAULZAGADE, Pune (IN); Shubham PENDHARKAR, Pune (IN); Anand Dinkar APTE, Pune (IN); Yogendra ACHARYA, Pune (IN)

(21) Appl. No.: 18/745,576

(22) Filed: Jun. 17, 2024

(30) Foreign Application Priority Data
Apr. 2, 2024 (IN) 202441027425

(51) Int. Cl. G06F 11/14

(52) U.S. Cl. CPC G06F 11/1464; G06F 2201/84

(57) ABSTRACT

A backup agent for performing a backup operation is provided. The backup agent comprises a memory storing one or more processor-executable routines and a processor communicatively coupled to a data storage system and configured to access unstructured data stored in therein. The processor comprises a master node and a plurality of proxy nodes. The master node is configured to perform a backup operation by generating a plurality of threads to perform a scan operation; wherein during the scan operation a plurality of batches of data stored on a data storage device is scanned. The processor is further configured to create a global queue of the plurality of batches of data upon completion of the scan and assign the plurality of batches of data from the global queue to a plurality of proxy nodes and/or to the master node. The master node and each proxy node are configured to perform an upload operation by uploading the assigned batch of data on the cloud network; wherein the master node and the proxy nodes operate concurrently.

### PRIORITY STATEMENT

The present application claims priority under 35 U.S.C. § 119 to Indian Patent Application number 202441027425 filed 2 Apr. 2024 the entire contents of which are hereby incorporated herein by reference.

### BACKGROUND

The invention generally relates to the field of storage systems and more particularly, to a system and method for performing a backup operation.

Data storage systems is used to store large amounts of unstructured data. Data, as is known, can be received from multiple systems across a network. An example of a data storage system is a NAS (Network Attached Storage) device. Typically, each data storage system stores large amounts of data that may be accessed by the host at any given time.

System administrators usually ensure that the data stored on the storage devices are backed up periodically to avoid loss of data during crisis. However, scanning and uploading the stored data requires the participation of multiple systems, which can be expensive and time consuming. For example, backing up data typically requires local copies to be made of all file systems. Such file systems may each be on the order of many terabytes and need to be scanned individually and then uploaded to a backup storage system.

More recently, several cloud-based storage solutions have been provided which are both cost effective and reliable. In such solutions, system administrators usually use a single proxy server to scan and upload data stored on the cloud network. However, because the scanned data is very large, it is manually broken down to multiple sections of data that is then scanned and uploaded using multiple proxy servers. However, this leads to either over or underutilization of proxy servers.

In addition, in regular multithreaded scanning, multiple threads scan independent directories. Typically, the start point is a directory that is enqueued for scanning. Any free thread will process the scan and if it encounters a child of the directory, the child directory is queued up for scanning, from where available threads will continue to process the scan. However, if any interruption occurs during the scanning operation, the entire data is scanned again upon resumption. This causes repeat scans, is time consuming and is not a very efficient process.

Therefore, there is a need for a system and a method that quickly and effectively back up data from a data storage device.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a backup agent for performing a backup operation is provided. The backup agent comprises a memory storing one or more processor-executable routines and a processor communicatively coupled to a data storage system and configured to access unstructured data stored in therein. The processor comprises a master node and a plurality of proxy nodes. The master node is configured to perform a backup operation by generating a plurality of threads to perform a scan operation; wherein during the scan operation a plurality of batches of data stored on a data storage device is scanned. The processor is further configured to create a global queue of the plurality of batches of data upon completion of the scan and assign the plurality of batches of data from the global queue to a plurality of proxy nodes and/or to the master node. The master node and each proxy node are configured to perform an upload operation by uploading the assigned batch of data on the cloud network; wherein the master node and the proxy nodes operate concurrently.

In another embodiment, a method for scanning and uploading data to a cloud network is provided. The method comprising accessing unstructured data from a data storage system and generating a plurality of threads for scanning the unstructured data; wherein the scanning is performed by a master node, creating a global queue of the scanned batches of data and assigning the scanned batches of data to a plurality of proxy nodes and the master node. The master node and the plurality of proxy nodes are configured to concurrently upload the corresponding batches of data to the cloud network.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram of an embodiment of a system performing a backup operation, implemented according to aspects of the present technique;

FIG. 2 illustrates an embodiment of an example embodiment of a backup agent comprising a master node and plurality of proxy nodes, implemented according to some aspects of the present technique;

FIG. 3 a process flow for performing checkpointing operation performed during a scanning operation, according to some aspects of the present technique;

FIG. 4 is an example checkpointing operation implemented according to aspects of the present technique; and

FIG. 5 is a block diagram of an embodiment of a computing device in which a system for performing a backup operation, described herein, are implemented.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or a section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Example embodiments of the present invention provide systems and methods for backing up data stored on data storage device to a cloud network using multiple proxy nodes.

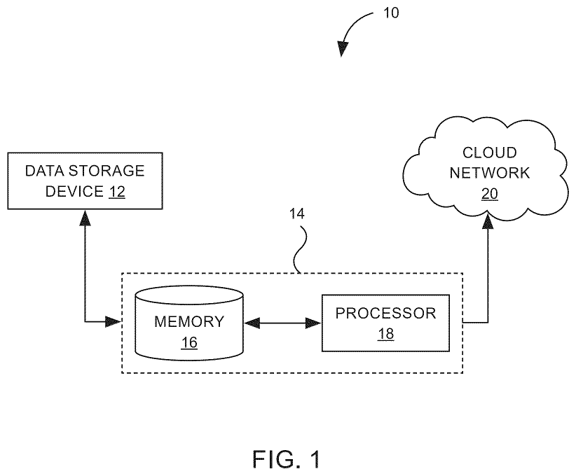

FIG. 1 is a block diagram of an embodiment of a system performing a backup operation, implemented according to aspects of the present technique. As used herein, a backup operation comprises two operations namely a scan operation and an upload operation. The system 10 comprises a data storage device 12, a backup agent 14 and cloud network 20. Each component is described in further detail below.

Data storage device 12 is configured to store large amounts of unstructured data received from various sources. In one embodiment, the data storage device is network attached storage (NAS) device. The data storage device is configured to store data received from various systems.

Backup agent 14 includes a memory 16 and a processor 18. The memory 16 stores one or more processor-executable instructions, and the processor 18 is communicatively coupled to the memory 16 to execute one or more processor-executable routines. Backup agent 14 is communicatively coupled to the data storage device 12 and to the cloud network 20. Backup agent 14 is configured to perform a backup operation to upload data from data storage device 12 to the cloud network 20.

The backup operation includes two operations-a scan operation and an uploading operation. During the scan operation, the unstructured data stored in the data storage device to is scanned to identify data to be backed up. During the upload operation, the data that is scanned is uploaded to the cloud network 20. The manner in which the backup agent 14 performs the scan operation and the upload operation is described in further detail below.

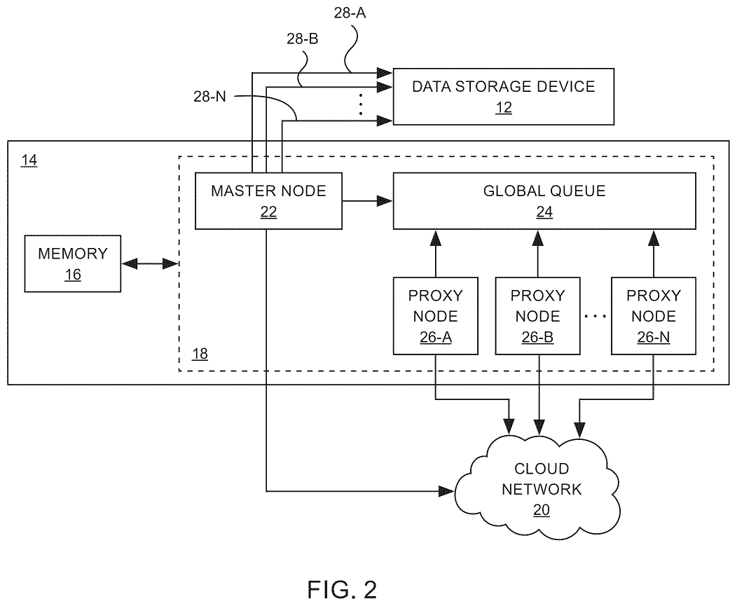

FIG. 2 is a block diagram of one embodiment of backup agent, implemented according to aspects of the present technique. The backup agent 14 is configured to perform a backup operation which includes scanning data from the data storage device and uploading the scanned data to the cloud network 20. The backup agent comprises memory 16 and processor 18 as described in FIG. 1. According to embodiments of the present technique, the processor 18 employs a master node 22 and a plurality of proxy nodes 26-A through 26-N to perform the backup operation as described herein. Although proxy nodes 26-A through 26-N are implemented using processor 18, it may be noted that the proxy nodes may be implemented using standalone processors as well. Each block is described in further detail below.

Master node 22 is configured to perform the scan operation by scanning the unstructured data stored in the data storage device and identify one or more batches of data for backing up on the cloud network 20. In one embodiment, the master node is configured to generate a plurality of threads 28-A through 28-N, each thread configured to scan data a corresponding batch of data stored on the data storage device. In one embodiment, a batch of data comprises directories and/or sub-directories.

Global queue 24 maintains an order in which the batches of data are being scanned by the master node 22. In one embodiment, the master node creates and updates the global queue as the scan operation makes progress to identify data to be backed up as described above. For example, threads 28-A through 28-N are configured to scan data stored in the data storage device in parallel.

Master node 22 is further configured to determine an availability of the one or more batches of data in the global queue, and upon availability, perform the upload operation which includes uploading the available batches of data to the cloud network. In one embodiment, the master node is configured to assign proxy nodes 26-A through 26-N. Further, it may be noted that the master node is also configured to upload the identified batch of data to the cloud network. Further, the batches of data are uploaded to the cloud concurrently. Proxy nodes 26-A through 26-N is further configured to communicate the status of the upload operation to the master node 22. In one embodiment, each proxy node is an independent node and may have an independent memory to execute the upload operation.

Master node 22 is configured to dynamically maintain a state map that indicates the progress of upload of each batch of data. In one embodiment, the status for each upload is labelled as “in progress” and complete. In the event that at least one of the proxy nodes 26-A through 26-N stops uploading during the backup operation, the progress of the corresponding proxy node on the state map continues to remain ‘in progress’. This corresponding batch of data will be reattempted to upload using the remaining operation nodes. Thus, the backup operation will continue even if one of the nodes has been rendered non-operational.

Master node 22 is further configured to perform a checkpointing operation during the scanning operation. The checkpointing operation is performed to ensure that the scanning operation is performed efficiently and to remove any repeat scans that may occur. The checkpointing operation is described in further detail below.

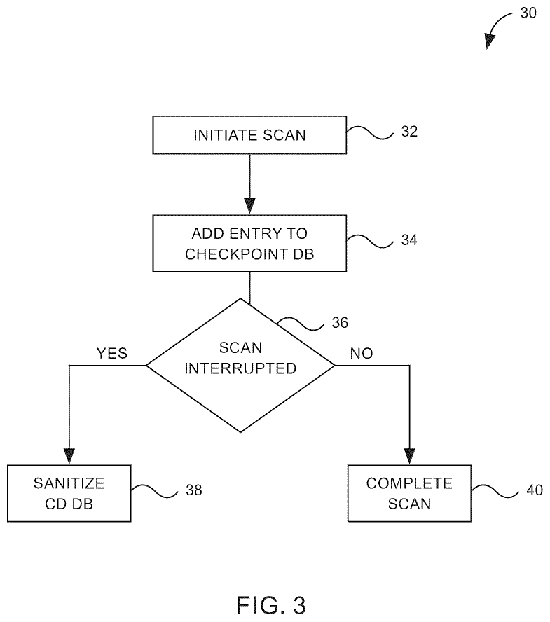

FIG. 3 is a flow chart illustrating a checkpointing operation implemented according to aspects of the present technique. It may be noted that the checkpointing operation is performed by the master node during the scan operation. The checkpointing operation begins when the master node generates a plurality of threads to parallelly scan data stored in the data storage device. Each step of the operation is described in further detail below.

At step 32, each thread initiates a scan operation to scan a specific batch of data stored in the data storage device. At any given instant, multiple threads are scanning data stored in the data storage device. As used herein batch of data may refer to a root directory, or directories, sub-directories and files stored within the root directory.

At step 34, an entry is added into the checkpoint database detailing the batch of data that is currently being scanned by each thread. The checkpoint database is dynamic and gets dynamically updated depending on the progress of scanning performed by each thread.

In many instances, a scan may be interrupted due to multiple reasons, as shown in step 36. If no interruption occurs, the thread proceeds to complete the scan as shown in step 40 and then becomes available for the next scan.

However, if an interruption occurs, then as shown in step 38, the checkpoint database is sanitized. During the sanitizing operation, the checkpoint database is analyzed to determine the point at which the interruption occurred, and all scan instants that occurred after that point is re-scanned. This ensures that repeat scanning is minimized thereby reducing repeat scans. The manner in which the checkpoint database is sanitized is explained with an example in detail below.

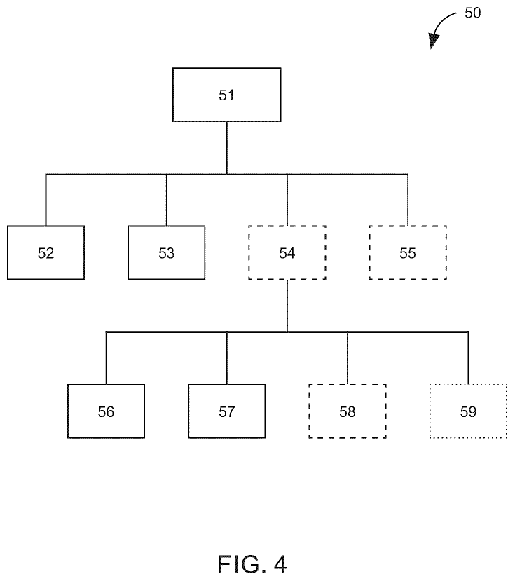

FIG. 4 is an example checkpointing operation performed by a master node, implemented according to aspects of the present technique. In this example, the scan operation 50 requires that data stored directory 51 be scanned for uploading. The directory 51 further includes four directories 52-55. Directory 54 further includes sub-directories 56, 58 and 59 and file 57.

Master node 22 generates multiple threads and each thread begins scanning a corresponding directory. Master node 22 generates a checkpoint database that follows the scanning progress of each directory. An example checkpoint database is shown below in Table 1.

TABLE 1

| Directory | Scan State |
|---|---|
| 51 | Complete |
| 52 | Complete |
| 53 | Complete |
| 54 | In Progress |
| 55 | In Progress |
| 56 | Complete |
| 58 | In Progress |
| 59 | Yet to Start |

It may be noted that file 57 is not populated in the above table is it is directly pushed into the global queue as it is a stand-alone file. Upon completion of scanning of the directory, the entry is removed from the checkpoint database. For example, Table 1 will be updated with only entries against 54, 55, and 58 as the scan state is in progress. Directories 51, 52, 53 and 56 will be deleted from the checkpoint database as the scan state is complete.

If the scanning process is interrupted at this instant, and when the scan is resumed, the master node is configured to sanitize the checkpoint database at that instant by removing any sub-directories present in the checkpoint database and including the parent directory instead. In the above example of table 1, directory 58 is removed from the checkpoint database and updated with directories 54 and 55 respectively. Thus, the scanning will resume from directory 54 and 55 and not from the start (that is, 51) thereby improving the efficiency of the scanning operation.

Thus, the checkpointing operation ensures rescanning of the already scanned directories is reduced. When scanning resumes, the scanning doesn't start from the very beginning and instead starts from the point where previous scanning was interrupted as described in the above example.

The various actions, acts, blocks, steps, or the like as described above may be performed in the order presented, in a different order or simultaneously. Further, in some embodiments, some of the actions, acts, blocks, steps, or the like may be omitted, added, modified, skipped, or the like without departing from the scope of the invention.

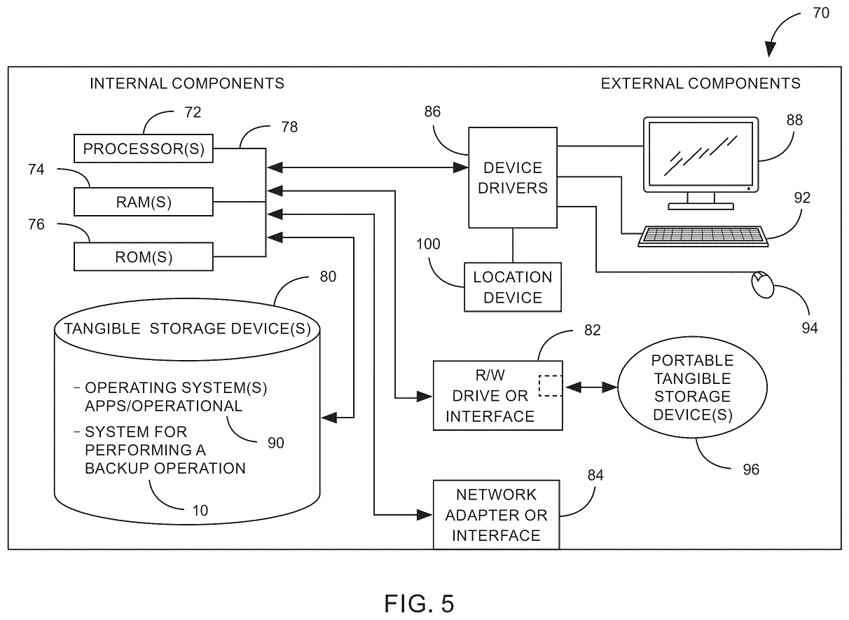

The backup agent described herein is implemented using a computing device such as computing device 70 is described below in FIG. 5. The computing device 70 includes one or more processor(s) 72, one or more computer-readable RAMs 74 and one or more computer-readable ROMs 76 on one or more buses 78. Further, computing device 70 includes a tangible storage device 80 that may include system 10 for performing a backup operation. The various modules of the system 10 may be stored in the tangible storage device 80. Both, the operating systems 90 and the system 10 are executed by the one or more processor(s) 72 via one or more respective RAMs 74 (which typically include cache memory). The execution of the operating systems 90 and/or the system 10 by the one or more processor(s) configures the one or more processor(s) as a special purpose processor configured to carry out the functionalities of the operation systems) and/or the system 10 as described above.

Examples of the tangible storage device include semiconductor storage devices such as ROM, EPROM, flash memory or any other computer-readable tangible storage device that may store a computer program and digital information.

Computing device 70 also includes a R/W drive or interface 82 to read from and write to one or more portable computer-readable tangible storage devices 96 such as a CD-ROM, DVD, memory stick or semiconductor storage device. Further, network adapters or interfaces 84 such as a TCP/IP adapter cards, wireless Wi-Fi interface cards, or 3G or 4G wireless interface cards or other wired or wireless communication links are also included in computing device.

In one example embodiment, the system 10 may be stored in the tangible storage device and may be downloaded from an external computer via a network (for example, the Internet, a local area network or other, wide area network) and network adapter or interface.

Computing device 70 further includes device drivers 86 to interface with input and output devices. The input and output devices may include a computer display monitor 88, a keyboard 92, a keypad, a touch screen, a computer mouse 94, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device main body or a removable medium arranged so that it may be separated from the computer device main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

What is claimed is:

1. A backup agent for performing a backup operation, the backup agent comprising:
a memory storing one or more processor-executable routines;
a processor communicatively coupled to a data storage device and configured to access unstructured data stored in therein, the processor comprising a master node and a plurality of proxy nodes, wherein the master node is configured to perform a backup operation comprising:
generating a plurality of threads to perform a scan operation; wherein during the scan operation a plurality of batches of data stored on a data storage device is scanned;
creating a global queue of the plurality of batches of data upon completion of the scan; and
assigning the plurality of batches of data from the global queue to a plurality of proxy nodes and/or to the master node; wherein the master node and each proxy node is configured to perform an upload operation by upload the assigned batch of data on the cloud network; wherein the master node and the proxy nodes operate concurrently.

2. The backup agent of claim 1, wherein the master node is further configured to dynamically maintain a state map; wherein the state map comprises a progress of the upload operation of each proxy node and the master node.

3. The backup agent of claim 2, wherein the proxy nodes are configured to provide a status update to the master node upon completion of its respective upload operation.

4. The backup agent of claim 3, wherein if the upload operation is interrupted at least one proxy node, the status update provided to the master node from the interrupted proxy node is “in progress.”

5. The backup agent of claim 1, wherein the master node is further configured to perform a checkpointing operation during the scan operation.

6. The backup agent of claim 1, wherein the master node is configured to maintain a checkpoint database while performing checkpointing operation; wherein the checkpoint database comprises progress of each thread for a corresponding batch of data.

7. The backup agent of claim 6, wherein master node is configured to dynamically update the checkpoint database with ‘in progress’ scans while deleting ‘completed scans.’

8. The backup agent of claim 7, wherein, upon interruption of the scan operation, the master node is configured to resume scanning ‘in progress’ scans.

9. The backup agent of claim 1, wherein the plurality of threads generated by the master node is configurable based on the plurality of batches of data.

10. The backup agent of claim 1, wherein the master node is further configured to maintain an order in which the batches of data are scanned.

11. A method for performing a backup operation, the method comprising:
accessing unstructured data from a data storage device,
performing a scanning operation by generating a plurality of threads to scan the unstructured data; wherein the scanning is performed by a master node;
identifying batches of data to be uploaded;
creating a global queue of batches of data to be uploaded; and
performing an upload operation by assigning the scanned batches of data to a plurality of proxy nodes and the master node; wherein the master node and the plurality of proxy nodes are configured to concurrently upload the corresponding batches of data to the cloud network.

12. The method of claim 11, further comprising dynamically maintaining a state map; wherein the state map comprises a progress of upload for each batch of data.

13. The method of claim 11, further comprising performing checkpointing operation to prevent repeat scanning of the unstructured data; wherein the checkpointing operation is performed by the master node.

14. The method of claim 13, wherein the checkpointing operation is performed by maintaining a checkpoint database; wherein the checkpoint database is indicative the progress of scan for each thread.

15. The method of claim 14, further comprising dynamically updating the checkpoint database with ‘in progress’ scans and deleting ‘completed scans.’
